(19) United States
(12) Patent Application Publication
(10) Pub. No.: US 2011/0309975 A1
(43) Pub. Date: Dec. 22, 2011

(54) Firearm Global Satellite Positioning System Tracking System

(76) Inventor: Charles CHU, Banciao City (TW)

(21) Appl. No.: 12/187,110

(22) Filed: Aug. 6, 2008

(30) Foreign Application Priority Data
Apr. 25, 2008 (TW) 097115184

(51) Int. Cl. G01S 19/42; G01S 19/14

(52) U.S. Cl. 342/357.25; 342/357.52

(57) ABSTRACT

A firearm GPS (Global Positioning System) tracking system, in which a GPS tracker is disposed within a firearm, and the GPS tracker is provided with a GPS receiving circuit, a microprocessor, a wireless transmission circuit and a detector. The detector is able to detect various operational circumstances of the firearm, moreover, detected information is transmitted to the microprocessor. Furthermore, the GPS receiving circuit receives geographic position satellite coordinate signals, which are matched with data prestored within a geographic data base to obtain the position of the firearm, whereupon the position is transmitted to the microprocessor. Accordingly, the microprocessor receives the position of the firearm from the GPS receiving circuit, and obtains the operational circumstances of the firearm from the detector, whereupon the information is transmitted to a remote server using the wireless transmission circuit for reference thereof.

### BACKGROUND OF THE INVENTION

(a) Field of the Invention

The present invention relates to a firearm GPS (Global Satellite Positioning System) tracking system, and more particularly to a GPS tracking system that is able to transmit various operational circumstances of a firearm to a remote server using wireless transmission.

(b) Description of the Prior Art

Since development of the global satellite positioning system (GPS) by the American Military, and after the government made the GPS open to public use, there has been continuous advancement in related technology and technical products, including application in various industries and at various levels, greatly increasing the standard of living of people and improving convenience in daily life, even accelerating notification of emergencies and the speed of medical rescue.

The global satellite positioning system consists of several deep space satellites, ground control stations and GPS receivers. Currently, there are 24 deep space satellites orbiting the Earth, and each of the deep space satellites equally maintain transmission of geographic position satellite coordinate signals carrying satellite orbit data and time for every type of terrestrial GPS receiver to receive. The ground control stations are responsible for tracing and controlling operation of each of the deep space satellites, as well as being responsible for correcting and maintaining each of the deep space satellites, thereby enabling normal continual transmission of each type of parameter data to the GPS receivers.

However, satellite navigators of the prior art are only able to indicate current position, route direction and neighboring buildings, and are not used to record operational circumstances of firearms, thus limiting use range thereof. Hence, there is still a need for developmental design of other uses for satellite navigators.

### SUMMARY OF THE INVENTION

Hence, in light of the shortcomings of the aforementioned prior art, the inventor of the present invention, having accumulated knowhow and manufacturing experience of a diverse range of GPSs (global satellite positioning systems), attentively researched various methods to resolve the shortcomings of the prior art, which, following continuous research and improvements, culminated in the design of a completely new firearm GPS tracking system.

The objective of the present invention is to provide a firearm GPS tracking system that is able to transmit various operational circumstances of a firearm to a remote server using wireless transmission and effectively control use of the firearm.

According to aforementioned objective, the firearm GPS tracking system of the present invention comprises a GPS tracker disposed within a firearm, and the GPS tracker is provided with a GPS receiving circuit, a microprocessor, a wireless transmission circuit and a detector. The detector is able to detect various operational circumstances (including: firing time, location, number of times fired, direction, and so on) of the firearm, moreover, detected information is transmitted to the microprocessor. Furthermore, the GPS receiving circuit receives geographic position satellite coordinate signals, which are matched with data prestored within a geographic data base to obtain the position of the firearm, whereupon the position is transmitted to the microprocessor. When in use, the microprocessor receives the position of the firearm from the GPS receiving circuit, and obtains the operational circumstances of the firearm from the detector, whereupon the information is transmitted to the remote server using the wireless transmission circuit for reference thereof. Accordingly, the remote server is able to acquire knowledge of the operational circumstances of the firearm, and enable effective control of the firearm.

To enable a further understanding of said objectives and the technological methods of the invention herein, a brief description of the drawings is provided below followed by a detailed description of the preferred embodiments.

### BRIEF DESCRIPTION OF THE DRAWINGS

FIGS. 1a, 1b show an elevational view and an external view respectively of a firearm GPS tracking system of the present invention.

FIG. 2 is an electric circuit block diagram of the firearm GPS tracking system of the present invention.

FIG. 3 depicts an operational flow chart of the firearm GPS tracking system according to the present invention.

### DETAILED DESCRIPTION OF THE PREFERRED EMBODIMENTS

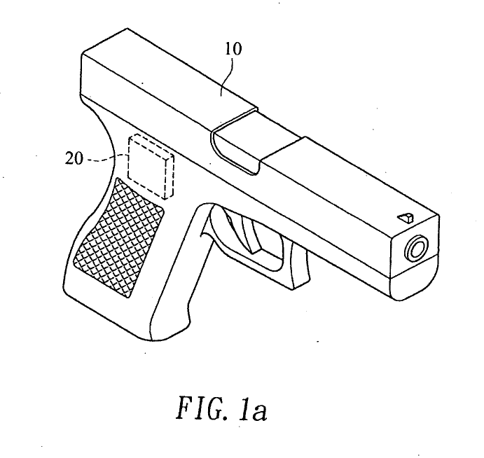

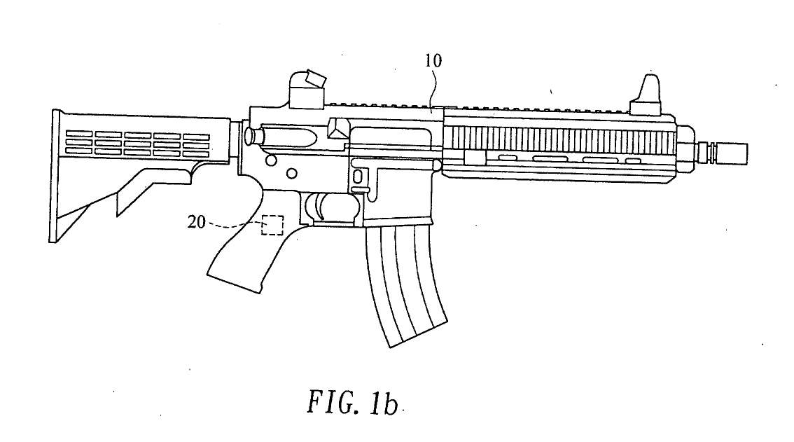

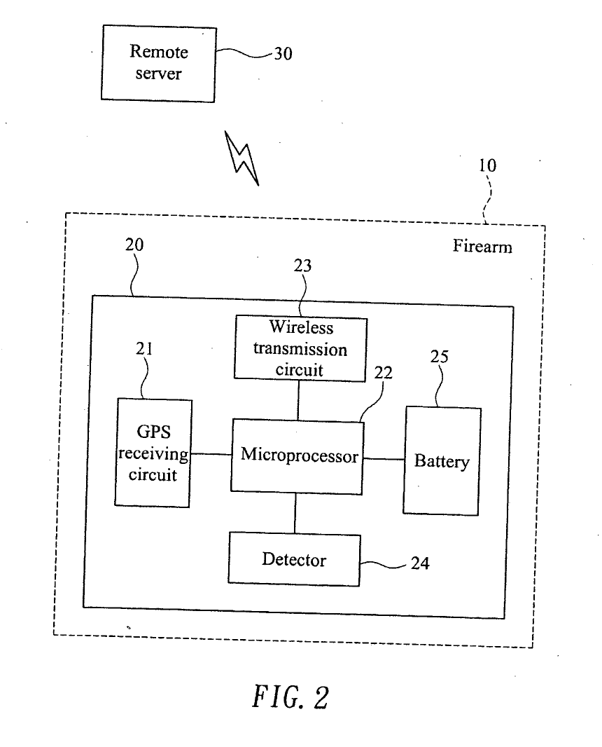

The present invention relates to a firearm GPS (global satellite positioning system) tracking system. Referring to FIGS. 1a, 1b and 2, which depict a firearm GPS tracking system of the present invention, wherein a GPS tracker 20 is disposed within a firearm 10, and the GPS tracker 20 is provided with a GPS receiving circuit 21, a microprocessor 22, a wireless transmission circuit 23 and a detector 24. The detector 24 is connected to the microprocessor 22, and is able to detect various operational circumstances (including: firing time, location, number of times fired, direction, and so on) of the firearm 10, moreover, detected information is transmitted to the microprocessor 22.

Furthermore, the GPS receiving circuit 21 is connected to the microprocessor 22, and is able to receive geographic position satellite coordinate signals, which are matched with data prestored within a geographic data base to obtain the time, position and altitude of the firearm 10, whereupon the time, position and altitude are transmitted to the microprocessor 22.

Furthermore, the wireless transmission circuit 23 is connected to the microprocessor 22, thereby enabling wireless transmission of transmitted data from the microprocessor 22 to a remote server 30.

According to the assembly of the aforementioned components, when in use, the microprocessor 22 receives the position, time and altitude of the firearm 10 obtained from the GPS receiving circuit 21, and obtains the various operational circumstances of the firearm 10 from the detector 24, whereupon the information is transmitted to the remote server 30 using the wireless transmission circuit 23 for reference thereof. Accordingly, the remote server 30 is able to acquire knowledge of the operational circumstances of the firearm 10, and enable effective control of the firearm 10.

Referring again to FIGS. 1a, 1b and 2, the detector 24 is able to detect various operational circumstances of the firearm 10 when firing bullets, including recoil, opening the safe mode, closing the safe mode, replacing the magazine, firing angle (for example: firing into the air or normal firing), and so on.

Referring again to FIGS. 1a, 1b and 2, the GPS receiving circuit 21 uses GPS, A-GPS (Assisted Global Positioning System) or GPSone (GPS One) satellite positioning technology, and the GPS information, including time, position, altitude and velocity, are combined within a report and transmitted to the remote server 30.

Referring again to FIGS. 1a, 1b and 2, communication medium of the wireless transmission circuit 23 comprises various types of wireless communication, including RF (radio frequency), GSM (Global System for Mobile Communications), GPRS (General Packet Radio Service), CDMA (Code Division Multiple Access), WiMAX (Worldwide Interoperability for Microwave Access) or satellite to satellite communication.

Referring again to FIGS. 1a, 1b and 2, the GPS tracker 20 comprises a battery 25 (such as a rechargeable battery), and the battery 25 supplies power to the GPS tracker 20, thus, when electric power is low, a battery charger (not shown in the drawings) (such as a charger cradle) can be used to connect to the battery 25 to carry out charging. In addition, a reserve battery (not shown in the drawings) is located in the magazine of the firearm 10; thereby replacing the magazine enables extending usage time of the GPS tracker 20.

Referring again to FIGS. 1a, 1b and 2, when the GPS signal is weak, the microprocessor 22 controls the wireless transmission circuit 23 to replace the GPS positioning signal with a GSM or CDMA base station positioning signal LBS (Location Based Service)/GPSone, or a function that automatically records the last time and position is used to record the position of the firearm 10.

Referring again to FIGS. 1a, 1b and 2, when the detector 24 has not detected use of the firearm 10 within a period of time, then the microprocessor 22 directs the GPS tracker 20 to enter a sleep mode, thereby achieving the objective of saving power.

Referring again to FIGS. 1a, 1b and 2, the firearm 10 can be a long-barrelled gun or a pistol, and the GPS tracker 20 can be installed in the handle of the firearm 10, thereby completely protecting the GPS tracker 20 from water. When the GPS tracker 20 is installed in a long-barrelled gun, then the detector 24 is able to detect safe modes (including: safe mode, semiautomatic mode, ammunition burst, fully automatic mode) of the firearm 10 and state of the trigger. If the firearm 10 is in the semiautomatic mode or fully automatic mode, when the trigger is pulled to fire a bullet, then the detector 24 detects that the firearm 10 is in a firing mode. If the firearm 10 is in the semiautomatic mode or the fully automatic mode, when the trigger is pulled and no bullets are fired, then the detector 24 detects malfunction (including jammed bullet) in the firearm 10 or that there is no bullets.

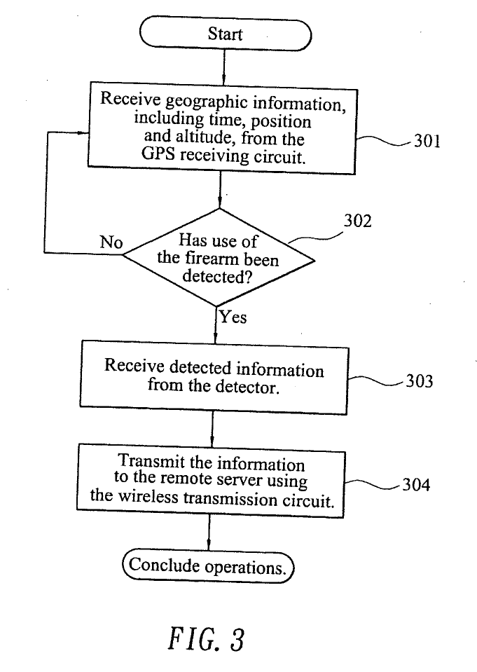

Referring to FIG. 2 and FIG. 3, when in use, the microprocessor 22 implements the following steps:

(301) First, receive geographic information, including time, position and altitude, of the firearm 10 transmitted by the GPS receiving circuit 21;

(302) Determine whether use of the firearm 10 has been detected or not? If yes, then continue to step (303), otherwise implement step (301);

(303) Receive detected information (including: firing time, location, number of times fired, direction, and so on) transmitted by the detector 24;

(304) Transmit the information to the remote server 30 using the wireless transmission circuit 23 for reference use thereof. Conclude operations.

In conclusion, the firearm GPS tracking system of the present invention is assuredly provided with an innovative structure not found in the prior art. Moreover, no similar products have been seen in any publication or in the market; the present invention is thus provided with undoubted originality. In addition, the present invention is provided with unique characteristics and functionality that are without comparison in the prior art. Hence, the incomparable advancement of the present invention clearly complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A firearm GPS (Global Positioning System) tracking system, wherein a GPS tracker is disposed within a firearm, and the GPS tracker comprises:
a microprocessor;
a detector connected to the microprocessor, the detector detects various operational circumstances of the firearm, and the detected information is transmitted to the microprocessor;
a GPS receiving circuit connected to the microprocessor, the GPS receiving circuit receives geographic position satellite coordinate signals, and the geographic position satellite coordinate signals are matched with data prestored within a geographic data base to obtain the time, position and altitude of the firearm, whereupon the time, position and altitude are transmitted to the microprocessor;
a wireless transmission circuit connected to the microprocessor, the wireless transmission circuit enables wireless transmission of transmitted data from the microprocessor to a remote server;
whereby the microprocessor obtains the position, time and altitude of the firearm from the GPS receiving circuit, and obtains various operational circumstances of the firearm from the detector, whereupon the information is transmitted to the remote server using the wireless transmission circuit.

2. The firearm GPS tracking system according to claim 1, wherein the detector detects various operational circumstances of the firearm when firing bullets, including recoil, opening the safe mode, closing the safe mode, replacing the magazine, firing angle (for example: firing into the air or normal firing), and so on.

3. The firearm GPS tracking system according to claim 1, wherein the communication medium of the wireless transmission circuit comprises various types of wireless communication, including RF (radio frequency), GSM (Global System for Mobile Communications), GPRS (General Packet Radio Service), CDMA (Code Division Multiple Access), WiMAX (Worldwide Interoperability for Microwave Access) or satellite to satellite communication.

4. The firearm GPS tracking system according to claim 1, wherein the GPS tracker comprises a battery, and the battery supplies power to the GPS tracker.

5. The firearm GPS tracking system according to claim 1, wherein when the detector has not detected use of the firearm within a period of time, then the microprocessor directs the GPS tracker to enter a sleep mode.

6. The firearm GPS tracking system according to claim 1, wherein the detector detects safe modes and state of the trigger.

7. The firearm GPS tracking system according to claim 1, wherein a reserve battery is located in the magazine of the firearm, thereby replacing the magazine enables extending usage time of the GPS tracker.
